(19) United States
(12) Patent Application Publication
(10) Pub. No.: US 2026/0316209 A1
(43) Pub. Date: Oct. 15, 2026

(54) CONTROL DEVICE, MACHINE TOOL SYSTEM, AND METHOD FOR CONTROLLING MACHINE TOOL

(71) Applicants: Mitsubishi Electric Corporation, Tokyo (JP); Oregon State University, Corvallis, OR (US)

(72) Inventors: Ryosuke IKEDA, Tokyo (JP); Kazuki TAKAHEI, Tokyo (JP); Burak SENCER, Corvallis, OR (US); Kaan BAHTIYAR, Corvallis, OR (US); Levent BOZCU, Corvallis, OR (US)

(73) Assignees: Mitsubishi Electric Corporation, Tokyo (JP); Oregon State University, Corvallis, OR (US)

(21) Appl. No.: 19/178,467

(22) Filed: Apr. 14, 2025

(51) Int. Cl. B23Q 15/12

(52) U.S. Cl. CPC B23Q 15/12; B23Q 2717/006

(57) ABSTRACT

A control device that controls a machine tool that cuts a workpiece through feed operation of a feed shaft attached to a tool and rotation operation of a spindle attached to the tool includes: a feature extraction unit that extracts, as a first frequency component, a frequency component of a spindle rotation frequency that is a frequency of rotation of the spindle from a sensor signal indicating vibration during cutting of the tool; a parameter update unit that adjusts a value of a correction parameter such that a first amplitude that is an amplitude of the first frequency component becomes equal to or less than a first threshold in a case where the first amplitude is larger than the first threshold; and an eccentricity correction unit that generates, based on the correction parameter, a correction command indicating a correction amount for a control command for controlling the feed shaft.

### BACKGROUND OF THE INVENTION

### 1. Technical Field of the Invention

The present disclosure relates to a control device, a machine tool system, and a method for controlling a machine tool with which the influence of vibration during cutting by the machine tool is reduced.

### 2. Description of the Related Art

In a machine tool that performs cutting while rotating a tool, vibration of the tool may occur during machining. Such vibration of the tool lowers the machining accuracy and may cause damage to the tool called chipping.

### SUMMARY OF THE INVENTION

A control device of the present disclosure is a control device that controls a machine tool that cuts a workpiece through feed operation of a feed shaft attached to a tool and rotation operation of a spindle attached to the tool, and includes: a feature extraction unit to extract, as a first frequency component, a frequency component of a spindle rotation frequency that is a frequency of rotation of the spindle from a sensor signal indicating vibration during cutting of the tool; a parameter update unit to adjust a value of a correction parameter such that a first amplitude that is an amplitude of the first frequency component becomes equal to or less than a first threshold in a case where the first amplitude is larger than the first threshold; and an eccentricity correction unit to generate, based on the correction parameter, a correction command indicating a correction amount for a control command for controlling the feed shaft.

### BRIEF DESCRIPTION OF THE DRAWINGS

FIG. 1 is a diagram illustrating an exemplary functional configuration of a machine tool system according to the first embodiment;

FIG. 2 is a diagram illustrating a definition of eccentricity of a four-blade tool;

FIG. 3 is a diagram describing frequency components that are extracted from a sensor signal by the feature extraction unit;

FIG. 4 is a diagram illustrating a frequency transfer function between the position command and the actual position on the X axis;

FIG. 5 is a diagram illustrating a frequency transfer function between the position command and the actual position on the Y axis;

FIG. 6 is a diagram illustrating an example of a display screen displayed by the display unit;

FIG. 7 is a flowchart for explaining a first example of the operation of the control device illustrated in FIG. 1;

FIG. 8 is a flowchart for explaining a second example of the operation of the control device illustrated in FIG. 1;

FIG. 9 is a diagram illustrating an exemplary functional configuration of a machine tool system according to the second embodiment;

FIG. 10 is a flowchart for explaining an example of the operation of the control device illustrated in FIG. 9;

FIG. 11 is a diagram illustrating an exemplary functional configuration of a machine tool system according to the third embodiment;

FIG. 12 is a diagram illustrating dedicated hardware for implementing the functions of the control devices according to the first to third embodiments; and

FIG. 13 is a diagram illustrating a configuration of the control circuit for implementing the functions of the control devices according to the first to third embodiments.

### DETAILED DESCRIPTION OF THE INVENTION

Hereinafter, embodiments of a control device, a machine tool system, and a method for controlling a machine tool according to the present disclosure will be described in detail with reference to the drawings.

### First Embodiment

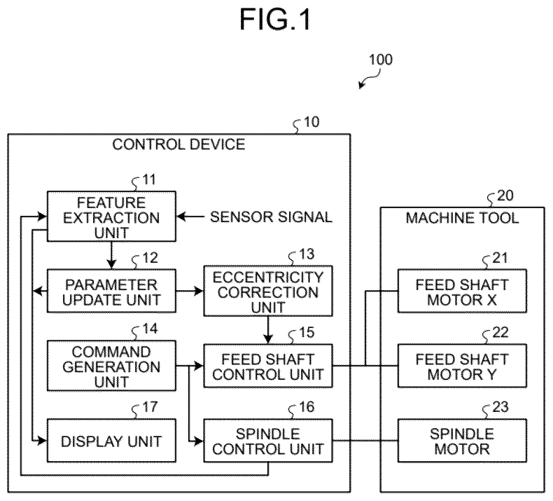

FIG. 1 is a diagram illustrating an exemplary functional configuration of a machine tool system 100 according to a first embodiment. The machine tool system 100 includes a control device 10 and a machine tool 20. The control device 10 is a device that controls the operation of the machine tool 20, and is, for example, a numerical control device. The machine tool 20 is a cutting device that performs cutting using a tool. The machine tool 20 includes a feed shaft motor X 21 that moves the feed shaft in the X-axis direction, a feed shaft motor Y 22 that moves the feed shaft in the Y-axis direction, and a spindle motor 23 that rotates the spindle about the Z axis. The machine tool 20 cuts a workpiece through feed operation of the feed shaft attached to the tool and rotation operation of the spindle attached to the tool.

The control device 10 has a function of correcting eccentricity. First, for understanding of premises in the function of correcting eccentricity, a case where the cutting force of milling generated when an end mill tool is eccentric is modeled will be described. Here, it is assumed that the cutting force is proportional to the cutting thickness.

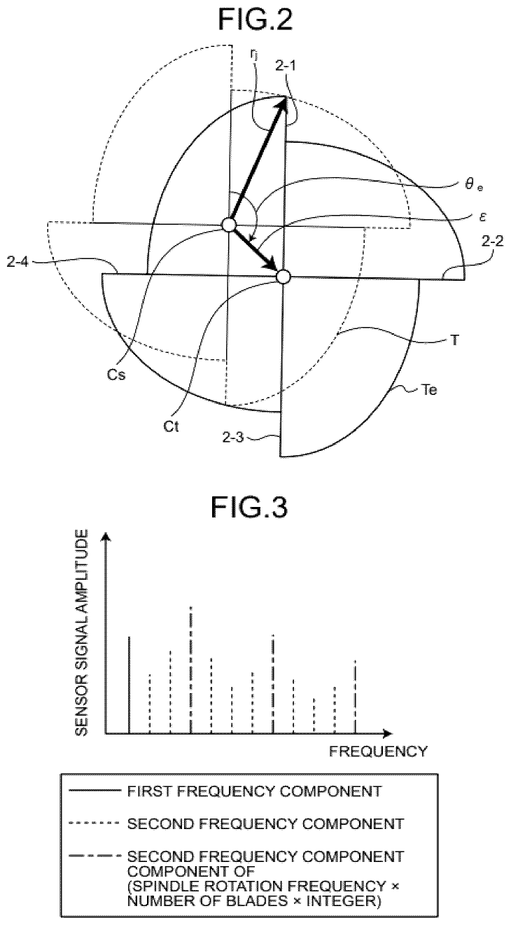

FIG. 2 is a diagram illustrating a definition of eccentricity of a four-blade tool. In FIG. 2, a tool in a non-eccentric state is illustrated as the tool T, and a tool in an eccentric state is illustrated as the tool Te. The eccentricity is defined as an offset of the center Ct of the tool T from the rotation center Cs of the spindle by the eccentricity vector ε. The deflection angle of the eccentricity vector ε with respect to the cutting blade 2-1 is denoted by θₑ. The tool radius of cutting blades 2-1 to 2-4 in this case is defined by the norm of the tool radius vector rⱼ (j=1, 2, 3, 4).

The cutting thickness h(φⱼ) is expressed by Formula (1) below.

h(φⱼ)=[c sin(φⱼ)+rⱼ−rⱼ₋₁]g(φⱼ) (1)

Here, φⱼ is the rotation angle of the spindle, j is the number of the blade, rⱼ is the current eccentricity amount of the blade, and rⱼ₋₁ is the eccentricity amount of the blade one cycle before. In addition, g(φⱼ) is a window function for determining whether cutting is being performed, and takes a value of one during cutting and otherwise takes a value of zero.

Here, a component h_{ecc} caused by the influence of the eccentricity amount in the cutting thickness h(φⱼ) is expressed by Formula (2) below.

$${r}_{j} = {r}_{nom , j} + ϵ cos ( {θ}_{ecc} + \frac{2 π}{N} ( j - 1 ) )$$

$$\begin{matrix}{h}_{ecc} ( {θ}_{j} ) = ( {r}_{j} - {r}_{j - 1} ) g ( {ϕ}_{j} ) \\ = [ ϵ cos ( {θ}_{ecc} + \frac{2 π}{N} ( j - 1 ) ) - ϵ cos ( {θ}_{ecc} + \frac{2 π}{N} ( j - 2 ) ) ] g ( {ϕ}_{j} ) \\ = ϵ [ cos ( {θ}_{ecc} + \frac{2 π}{N} j - \frac{2 π}{N} ) - cos ( {θ}_{ecc} + \frac{2 π}{N} j - \frac{4 π}{N} ) ] g ( {ϕ}_{j} )\end{matrix} \qquad ( 2 )$$

$$Define , α = {θ}_{ecc} + \frac{2 π}{N} j , ⋯ β = \frac{2 π}{N}$$

$$\begin{matrix}{h}_{ecc} ( {θ}_{j} ) = ϵ [ cos ( α - β ) - cos ( α - 2 β ) ] g ( {ϕ}_{j} ) \\ = σ [ - 2 sin ( \frac{β}{2} ) sin ( α - \frac{3 β}{2} ) ] g ( {ϕ}_{j} )\end{matrix}$$

$${h}_{ecc} ( {θ}_{j} ) = - 2 ϵ sin ( \frac{π}{N} ) sin ( {θ}_{ecc} + \frac{2 π}{N} j - \frac{3 π}{N} ) g ( {ϕ}_{j} )$$

Here, θⱼ is the angle of the cutting blade 2-j of the tool T, N is the number of cutting blades of the tool T, and ε is the amplitude of whirling of the tool T due to eccentricity. The window function g(φⱼ) is a periodic function generated in a rectangular wave shape according to the rotation angle φⱼ of the spindle. Therefore, the component h_{ecc} caused by the influence of the eccentricity amount in the cutting thickness h(φⱼ) can be expressed by superposition of sine waves of a component of the rotational speed of the spindle and a component of harmonics thereof by Fourier series expansion.

Since the cutting force is proportional to the cutting thickness h(φⱼ), the fluctuation of the cutting force caused by the influence of the eccentricity amount can also be expressed by superposition of sine waves of a component of the rotational speed of the spindle and a component of harmonics thereof. Thus, the eccentricity of the tool can be eliminated by adding the sine wave of the component of the rotation speed of the spindle to the position command for the feed shaft and adjusting the amplitude and phase thereof such that the component of the rotational speed of the spindle in the cutting force is reduced. Furthermore, the effect of eliminating the eccentricity of the tool can be enhanced by performing adjustment such that the harmonic component of the rotational speed of the spindle in the cutting force is reduced.

According to the model described above, the eccentric component of the cutting force is sinusoidal. Therefore, the control device 10 has a function of correcting eccentricity by adding a sine wave to a control command for controlling the feed shaft and adjusting the amplitude and phase thereof. At this time, a command indicating a waveform to be added to the control command is referred to as a correction command. A parameter for determining the waveform of the correction command is referred to as a correction parameter. The control device 10 has a function of adjusting the correction parameter from a sensor signal indicating the vibration of the tool so as to reduce the influence of eccentricity in the frequency component of the spindle rotation frequency that is the frequency of the spindle rotation and a frequency component that is an integral multiple of the spindle rotation frequency. This function will be described below.

Returning to FIG. 1, the control device 10 includes a feature extraction unit 11 that extracts a frequency component from a sensor signal, a parameter update unit 12 that adjusts a correction parameter for correcting a control command for controlling the feed shaft by superimposing vibration on the control command so as to reduce the frequency component extracted by the feature extraction unit 11, an eccentricity correction unit 13 that generates a correction command indicating a correction amount for the control command using the correction parameter adjusted by the parameter update unit 12, a command generation unit 14 that generates a control command, a feed shaft control unit 15 that controls the feed shaft of the machine tool 20, a spindle control unit 16 that controls the spindle of the machine tool 20, and a display unit 17 that is an output unit for providing information to a user of the machine tool system 100.

The feature extraction unit 11 extracts a specific frequency component from the sensor signal, and outputs the amplitude of the extracted frequency component to the parameter update unit 12 as a feature. In addition, the feature extraction unit 11 may output the extracted feature to the display unit 17. The frequency component extracted by the feature extraction unit 11 includes at least the frequency component of the spindle rotation frequency that is the frequency of rotation of the spindle of the machine tool 20. The frequency component of the spindle rotation frequency is referred to as the first frequency component. In addition to the first frequency component, the feature extraction unit 11 may extract a frequency component that is an integral multiple of the spindle rotation frequency as a second frequency component. The feature extraction unit 11 can use, for example, discrete Fourier transform, fast Fourier transform, or the like.

FIG. 3 is a diagram describing frequency components that are extracted from a sensor signal by the feature extraction unit 11. The frequency component indicated by a solid line in FIG. 3 is the first frequency component, and the frequency components indicated by broken lines and alternate long and short dash lines are second frequency components. When normal cutting is performed and there is no eccentricity, only components of the spindle rotation frequency×the number of blades×an integer are generated, such as the second frequency components represented by the alternate long and short dash lines. FIG. 3 illustrates a case where the number of blades is four, and the second frequency components correspond to the frequencies of four times, eight times, and twelve times the spindle rotation frequency.

Returning to FIG. 1, the parameter update unit 12 adjusts the value of the correction parameter that is used by the eccentricity correction unit 13 to generate a correction command based on the feature output by the feature extraction unit 11. The correction parameter is a parameter for determining the waveform of the correction command. For example, when the correction command is a sine wave having an angular velocity of the spindle rotation frequency, the correction parameter can be the amplitude of the sine wave and the phase with respect to the spindle angle. The parameter update unit 12 adjusts the value of the correction parameter such that the feature output from the feature extraction unit 11 approaches the feature at the time when cutting is performed in a normal state without eccentricity. Specifically, in a case where a first amplitude that is the amplitude of the first frequency component is larger than a first threshold, the parameter update unit 12 adjusts the value of the correction parameter such that the first amplitude becomes equal to or less than the first threshold. The parameter update unit 12 maintains the value of the correction parameter in a case where the first amplitude is equal to or less than the first threshold. The parameter update unit 12 outputs the correction parameter to the eccentricity correction unit 13. When the feature extraction unit 11 outputs a second frequency component in addition to the first frequency component, in a case where the first amplitude is larger than the first threshold or a second amplitude that is the amplitude of the second frequency component is larger than a second threshold, the parameter update unit 12 adjusts the correction parameter such that the first amplitude becomes equal to or less than the first threshold and the second amplitude becomes equal to or less than the second threshold. The parameter update unit 12 outputs the current correction parameter to the eccentricity correction unit 13.

The first threshold and the second threshold may be, for example, values determined by the user based on experience. It is desirable that each of the first threshold and the second threshold be determined based on the feature at the time when there is no eccentricity and cutting is normally performed. For example, each of the first threshold and the second threshold can be a value obtained by adding an allowable error to the amplitude of the corresponding frequency component in the sensor signal at the time when there is no eccentricity and cutting is normally performed.

Various methods can be considered for adjusting the correction parameter by the parameter update unit 12. For example, the parameter update unit 12 selects one of the correction parameters, and adjusts the correction parameter based on the change in the feature with respect to the change in the correction parameter while gradually increasing the selected correction parameter with time. The parameter update unit 12 reduces the correction parameter if the feature increases as the correction parameter is increased, and increases the correction parameter if the feature decreases as the correction parameter is increased. Alternatively, the parameter update unit 12 increases the correction parameter if the feature increases as the correction parameter is reduced, and reduces the correction parameter if the feature decreases as the correction parameter is reduced.

Another example of a method for adjusting the correction parameter by the parameter update unit 12 is to search for correction parameters using an optimum control method such as extreme value search control. In this method, the influence of the change in the correction parameter on the increase or decrease in the feature is evaluated by adding a periodic perturbation to the correction parameter to be optimized. This perturbation is realized as a sine wave signal having a sufficiently small amplitude compared to the amplitude R of the eccentricity correction amount, thereby enabling a continuous and periodic search for correction parameters. Since the amplitude of the eccentricity correction amount is generally around 10 μm, the amplitude of the perturbation can be 1 μm, for example. The parameter update unit 12 can observe a change in the feature obtained as a result of the addition of the perturbation, and determine whether to increase or decrease the correction parameter based on the change. Consequently, it is possible to efficiently search for the value of the correction parameter that minimizes the vibration amplitude.

The eccentricity correction unit 13 generates a correction command indicating a correction amount for the control command for controlling the feed shaft based on the correction parameter output from the parameter update unit 12. Given that the correction amount given to the X axis is X, the correction amount given to the Y axis is Y, the amplitude of the target eccentricity correction amount is R, the angular velocity of the spindle rotation speed is w, the time is t, the coefficient for correcting the difference in amplitude between the position command and the actual position on the X axis is R1, the coefficient for correcting the difference in amplitude between the position command and the actual position on the Y axis is R2, the coefficient for correcting the difference in phase between the position command and the actual position on the X axis is 01, and the coefficient for correcting the difference in phase between the position command and the actual position on the Y axis is φ₂, the correction amount X is expressed by Formula (3) below, and the correction amount Y is expressed by Formula (4) below.

X=(R×R1)×cos(wt+φ₁) (3)

Y=(R×R2)×sin(wt+φ₂) (4)

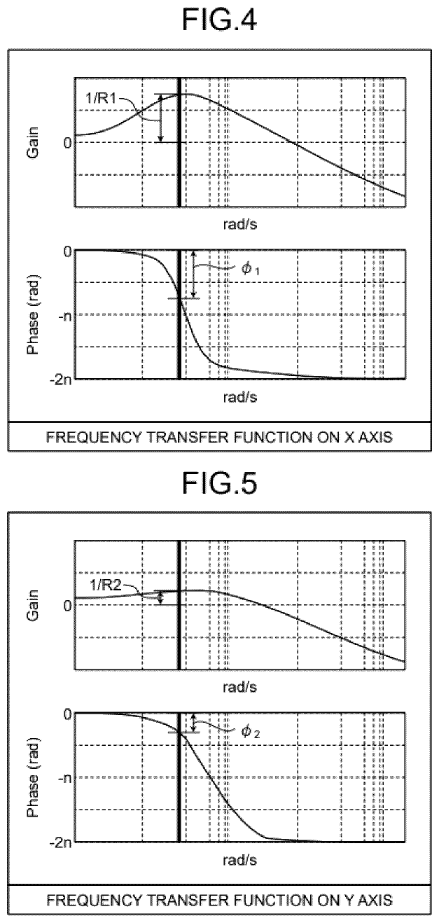

FIG. 4 is a diagram illustrating a frequency transfer function between the position command and the actual position on the X axis. FIG. 5 is a diagram illustrating a frequency transfer function between the position command and the actual position on the Y axis. As illustrated in FIGS. 4 and 5, the actual position with respect to the position command is affected by the transmission characteristics of the control system and the feed shaft, thereby having the amplitude and phase shifted. The control device 10 can more accurately correct the influence of the vibration of the tool by correcting the eccentricity in consideration of the shift.

Note that, since it takes time and effort to measure the shift of the control system in advance, the eccentricity correction unit 13 sequentially calculates the feature at the time when the correction parameters R1, R2, φ₁, and φ₂ are changed during cutting in the parameter update unit 12, and generates the correction command using the correction parameter adjusted such that the feature becomes equal to or less than the threshold.

Regarding the amplitude, R has been separated from R1 and R2 for the explanation of the principle. However, in actual correction amount calculation, each amount is calculated with multiplication: R×R1 and R×R2. In addition, in order to simplify the calculation, the transmission characteristics of the X axis and the Y axis may be assumed to be similar, and the correction amount may be calculated by reducing the number of correction parameters with R1=R2 and (1=02.

Returning to FIG. 1, the eccentricity correction unit 13 generates a sine wave to be added to the control command as a correction command by using Formulas (3) and (4) above and the correction parameters R1, R2, φ₁, and φ₂ output by the parameter update unit 12. The eccentricity correction unit 13 outputs the generated correction command to the feed shaft control unit 15.

The command generation unit 14 analyzes the machining program and calculates a control command indicating the state of the position and angle at every moment to be realized by the feed shaft motor X 21, the feed shaft motor Y 22, and the spindle motor 23. The control command is a position command, a speed command, or the like. The command generation unit 14 outputs the generated control command to each of the feed shaft control unit 15 and the spindle control unit 16.

The feed shaft control unit 15 calculates a control signal for controlling the position, speed, and current of the feed shaft motor X 21 and the feed shaft motor Y 22 based on the control command generated by the command generation unit 14 and the correction command output by the eccentricity correction unit 13. Specifically, the feed shaft control unit 15 calculates the control signal such that the feed shaft moves to a position obtained by superimposing the sine wave indicated by the correction command on the position at every moment indicated by the control command. Note that the feed shaft control unit 15 may superimpose the correction command on the speed command. The feed shaft control unit 15 outputs the control signal at every moment to the feed shaft motor X 21 and the feed shaft motor Y 22.

The spindle control unit 16 calculates a control signal for controlling the angle, rotation angle, and current of the spindle motor 23 in accordance with the angle at every moment indicated by the control command output by the command generation unit 14. The spindle control unit 16 outputs the control signal at every moment to the spindle motor 23. In addition, the spindle control unit 16 outputs the spindle rotation frequency at every moment to the feature extraction unit 11.

The display unit 17 provides information to the user of the machine tool system 100 using a display screen. The display unit 17 displays the frequency component extracted by the feature extraction unit 11 and/or the correction parameter adjusted by the parameter update unit 12. At this time, the display unit 17 displays the absolute value and time-series change of a value in a visually recognizable manner.

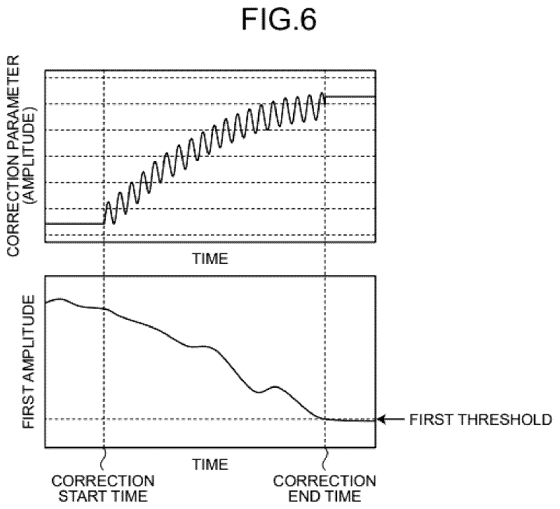

FIG. 6 is a diagram illustrating an example of a display screen displayed by the display unit 17. FIG. 6 illustrates an example in which the first amplitude and the amplitude of the sine wave among the correction parameters are displayed in time series. Searched with the extreme value search control described above, the correction parameter changes such that the first amplitude decreases with a minute sinusoidal variation as the time elapses. Displaying such a display screen to the user has an effect that the user can visually recognize the completion of the correction.

Note that although FIG. 6 illustrates an example of displaying the amplitude among the correction parameters, the phase may be displayed in a similar manner, or both the amplitude and the phase may be displayed. In this case, a similar effect can be obtained.

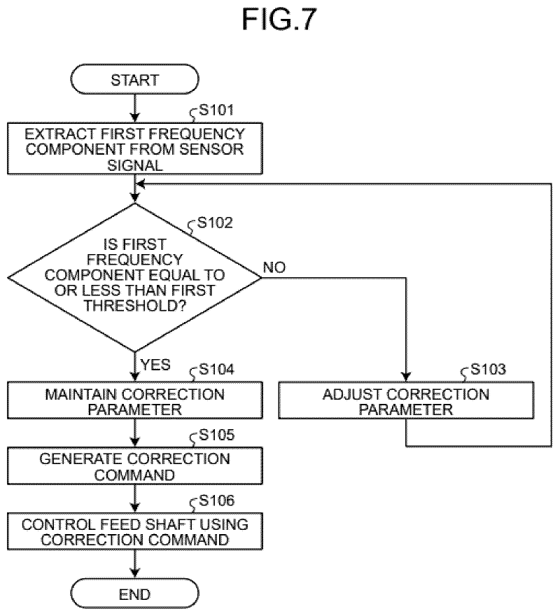

FIG. 7 is a flowchart for explaining a first example of the operation of the control device 10 illustrated in FIG. 1. The first example illustrated in FIG. 7 is an example in which the feature extraction unit 11 of the control device 10 extracts only the first frequency component from the sensor signal.

The feature extraction unit 11 of the control device 10 extracts the first frequency component from the sensor signal (step S101). The parameter update unit 12 determines whether the first amplitude that is the amplitude of the first frequency component is equal to or less than the first threshold (step S102). If the first amplitude is larger than the first threshold (step S102: No), the parameter update unit 12 adjusts the correction parameter (step S103), and returns to step S102.

If the first amplitude is equal to or less than the first threshold (step S102: Yes), the parameter update unit 12 maintains the correction parameter (step S104), and outputs the correction parameter to the eccentricity correction unit 13.

The eccentricity correction unit 13 generates and outputs a correction command to the feed shaft control unit 15 (step S105), and the feed shaft control unit 15 controls the feed shaft using the correction command (step S106).

Consequently, the control device 10 can control the feed shaft while repeating the adjustment of the correction parameter until the first amplitude becomes equal to or less than the first threshold and correcting the eccentricity based on the correction parameter that makes the first amplitude equal to or less than the first threshold.

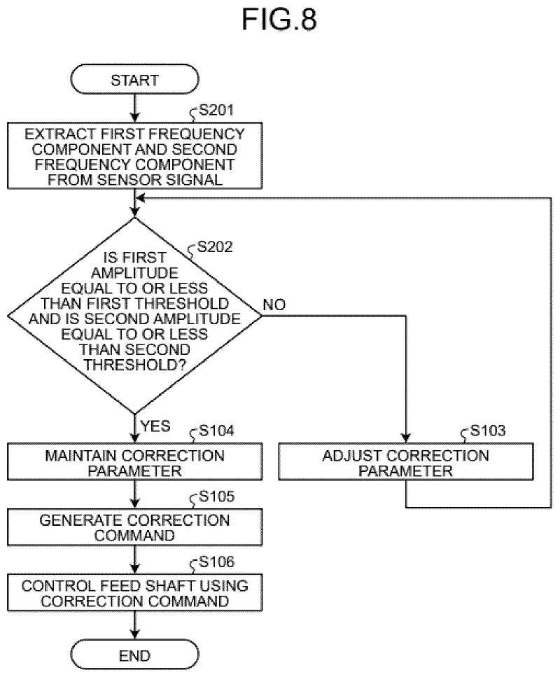

FIG. 8 is a flowchart for explaining a second example of the operation of the control device 10 illustrated in FIG. 1. The second example illustrated in FIG. 8 is an example in which the feature extraction unit 11 of the control device 10 extracts the first frequency component and the second frequency component from the sensor signal.

The feature extraction unit 11 of the control device 10 extracts the first frequency component and the second frequency component from the sensor signal (step S201). Note that the feature extraction unit 11 can extract a plurality of second frequency components.

The parameter update unit 12 determines whether the first amplitude is equal to or less than the first threshold and the second amplitude is equal to or less than the second threshold (step S202). If the first amplitude and the second amplitude are not equal to or less than the first threshold and the second threshold, respectively (step S202: No), that is, if a condition that the first amplitude exceeds the first threshold and/or a condition that the second amplitude exceeds the second threshold is satisfied, the control device 10 proceeds to step S103. If the first amplitude is equal to or less than the first threshold and the second amplitude is equal to or less than the second threshold (step S202: Yes), the control device 10 proceeds to step S104. The subsequent processes are similar to those in the first example illustrated in FIG. 7.

Note that, in a case where the feature extraction unit 11 extracts a plurality of second frequency components, the second thresholds used by the parameter update unit 12 in the determination in step S202 can differ between the second frequency components. For example, in the example illustrated in FIG. 3, the second frequency components having frequencies of four times, eight times, and twelve times the spindle rotation frequency indicated by the alternate long and short dash lines are components that occur also when there is no eccentricity and normal cutting is performed, and the other second frequency components having frequencies indicated by the broken lines are components that do not occur when there is no eccentricity and normal cutting is performed. Therefore, the second frequency components indicated by the alternate long and short dash lines and the frequency components indicated by the broken lines have different second thresholds.

As described above, the first embodiment can provide the control device 10 that controls a machine tool that cuts a workpiece through feed operation of a feed shaft attached to a tool and rotation operation of a spindle attached to the tool, the control device 10 including: the feature extraction unit 11 that extracts, as a first frequency component, a frequency component of a spindle rotation frequency that is a frequency of rotation of the spindle from a sensor signal indicating vibration during cutting of the tool; the parameter update unit 12 that adjusts a value of a correction parameter such that a first amplitude that is an amplitude of the first frequency component becomes equal to or less than a first threshold in a case where the first amplitude is larger than the first threshold; and the eccentricity correction unit 13 that generates, based on the correction parameter, a correction command indicating a correction amount for a control command for controlling the feed shaft.

For example, Japanese Patent No. 5908342 by Inagaki et al. discloses a technique in which machining is performed by applying a forced vibration having a cycle equal to the rotation speed of the tool to the feed operation to cancel the influence of the tool deflection amount. In this related art, the forced vibration of the deflection amount measured in advance is applied. In this case, if a control delay occurs, vibration suppression cannot be appropriately performed, and problems such as deterioration in machining accuracy and occurrence of chipping are not solved.

On the other hand, the control device 10 determines the correction amount based on the sensor signal acquired during cutting, and thus can accurately correct the influence of the tool vibration caused by the eccentricity in consideration of the response of the machine tool 20 during cutting. Therefore, even when a control delay occurs, it is possible to improve machining accuracy and prevent chipping of the tool.

In addition, the feature extraction unit 11 may further extract, from the sensor signal, a second frequency component that is a frequency component of an integral multiple of the spindle rotation frequency. In this case, in a case where the first amplitude is larger than the first threshold or a second amplitude that is an amplitude of the second frequency component is larger than a second threshold, the parameter update unit 12 adjusts the correction parameter such that the first amplitude becomes equal to or less than the first threshold and the second amplitude becomes equal to or less than the second threshold. With such a configuration, the control device 10 can more accurately correct the influence of the vibration of the tool caused by the eccentricity.

Note that the correction command may be a sine wave having an angular velocity of the spindle rotation frequency, and the correction parameter may be an amplitude of the sine wave and a phase with respect to a spindle angle.

In addition, the control device 10 can further include the display unit 17 that displays the frequency component extracted by the feature extraction unit 11 and/or the correction parameter adjusted by the parameter update unit 12. The display unit 17 can display an absolute value and a time-series change of a value in a visually recognizable manner. With such a configuration, the user of the machine tool system 100 can visually determine the effect of the eccentricity correction function. In addition, it is possible to confirm whether the machining error due to eccentricity has been reduced by comparing the machining result with the time-series correction parameter after the cutting. In addition, it is possible to select whether to use the same correction parameter when cutting a next workpiece with the tool currently attached to the machine tool 20.

In addition, the first embodiment can also provide the machine tool system 100 including: the machine tool 20 that cuts a workpiece through feed operation of a feed shaft attached to a tool and rotation operation of a spindle attached to the tool; and the control device 10 that controls the machine tool 20.

In addition, the first embodiment can provide a method for controlling the machine tool 20 that cuts a workpiece through feed operation of a feed shaft attached to a tool and rotation operation of a spindle attached to the tool, the method including: a step of extracting, as a first frequency component, a frequency component of a spindle rotation frequency that is a frequency of rotation of the spindle from a sensor signal indicating vibration during cutting of the tool; a step of adjusting a value of a correction parameter such that a first amplitude that is an amplitude of the first frequency component becomes equal to or less than a first threshold in a case where the first amplitude is larger than the first threshold; and a step of generating, based on the correction parameter, a correction command indicating a correction amount for a control command for controlling the feed shaft.

### Second Embodiment

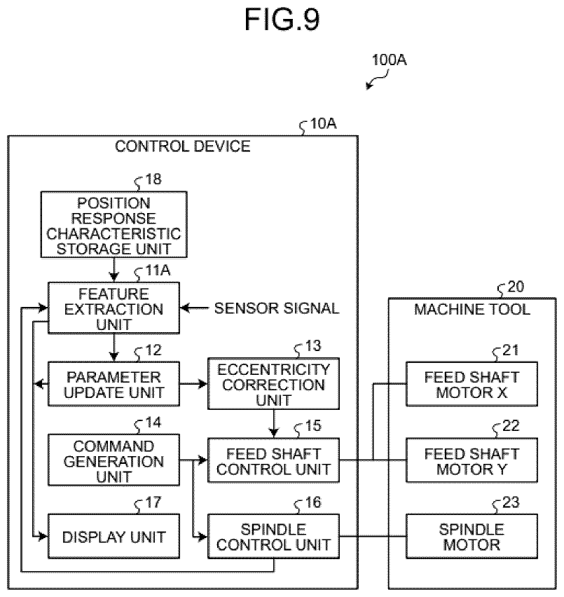

FIG. 9 is a diagram illustrating an exemplary functional configuration of a machine tool system 100A according to a second embodiment. The machine tool system 100A includes a control device 10A and the machine tool 20.

Generally, cutting is performed at various spindle rotation speeds set by a user. For this reason, the first frequency component and the second frequency component that depend on the spindle rotation speed are generated. Here, the vibration actually generated is affected by the vibration characteristics of the machine tool 20 and the spindle structure. Even if the eccentricity amount is the same at various spindle rotation speeds and the fluctuation of the cutting disturbance due to the eccentricity is the same, the magnitude of the generated vibration varies depending on the spindle rotation speed due to the influence of the resonance. Therefore, in the second embodiment, the control device 10A has a function of measuring in advance vibration characteristics of vibration that are output in response to input of a disturbance, correcting the vibration level acquired according to the spindle rotation speed to cancel the influence of mechanical resonance, and then correcting eccentricity. The vibration characteristics refer to a frequency transfer function obtained by actual measurement, a state space model obtained by fitting to the frequency transfer function, a transfer function model, and the like.

The control device 10A includes a feature extraction unit 11A, the parameter update unit 12, the eccentricity correction unit 13, the command generation unit 14, the feed shaft control unit 15, the spindle control unit 16, the display unit 17, and a position response characteristic storage unit 18. That is, the control device 10A includes the feature extraction unit 11A instead of the feature extraction unit 11 of the control device 10 according to the first embodiment, and further includes the position response characteristic storage unit 18. Hereinafter, detailed description of similarities to the first embodiment will be omitted, and differences from the first embodiment will be mainly described.

The position response characteristic storage unit 18 stores previously measured values of the gain and the phase of the actual position with respect to the command position of the feed shaft in association with the value of the spindle rotation frequency. The position response characteristic storage unit 18 can output the stored values to the feature extraction unit 11A.

The feature extraction unit 11A extracts the first frequency component and the second frequency component. In addition, the feature extraction unit 11A acquires previously measured values of the gain and the phase of the actual position associated with the current value of the spindle rotation frequency from the position response characteristic storage unit 18, corrects the extracted first frequency component and second frequency component based on the acquired values, and outputs the corrected first frequency component and second frequency component to the parameter update unit 12. Specifically, the feature extraction unit 11A corrects the gain and the phase of the extracted first frequency component and second frequency component such that the amplitude of the actual position at the time when the feed shaft is controlled based on the correction command coincides with the amplitude of the command position, and the phase difference of the actual position with respect to the correction command decreases.

The parameter update unit 12 adjusts the correction parameter based on the corrected first frequency component and second frequency component.

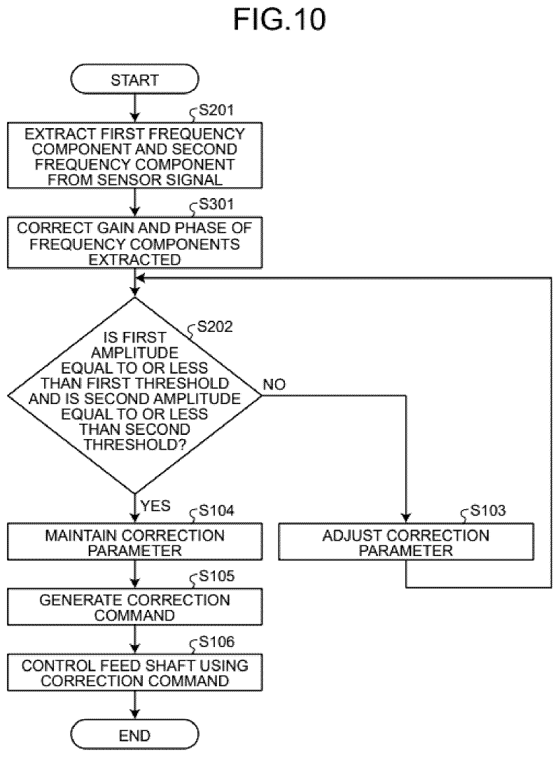

FIG. 10 is a flowchart for explaining an example of the operation of the control device 10A illustrated in FIG. 9.

The feature extraction unit 11A of the control device 10A extracts the first frequency component and the second frequency component from the sensor signal (step S201). The feature extraction unit 11A corrects the gain and the phase of the frequency components extracted in step S201 using the information stored in the position response characteristic storage unit 18 (step S301). The processes after step S202 are similar to those in FIG. 8, and thus the description thereof is omitted here.

Note that, although an example in which the feature extraction unit 11A extracts the first frequency component and the second frequency component has been described here, the feature extraction unit 11A may extract only the first frequency component and may not extract the second frequency component as in the first embodiment. In a case where the feature extraction unit 11A does not extract the second frequency component, step S301 is executed between step S101 and step S102 illustrated in FIG. 7.

As described above, the control device 10A according to the second embodiment further includes the position response characteristic storage unit 18 that stores previously measured values of a gain and a phase of an actual position with respect to a command position of the feed shaft in association with the spindle rotation frequency. In addition, the feature extraction unit 11A corrects a gain and a phase of the frequency component extracted such that an amplitude of the actual position at a time when the feed shaft is controlled based on the correction command coincides with an amplitude of the command position and a phase difference of the actual position with respect to the correction command decreases, and the parameter update unit 12 adjusts the correction parameter based on the frequency component after correction. Consequently, it is possible to prevent a specific frequency from being excessively detected due to the influence of mechanical resonance, evaluate only a vibration component caused by eccentricity of the tool, and perform eccentricity correction with high accuracy.

### Third Embodiment

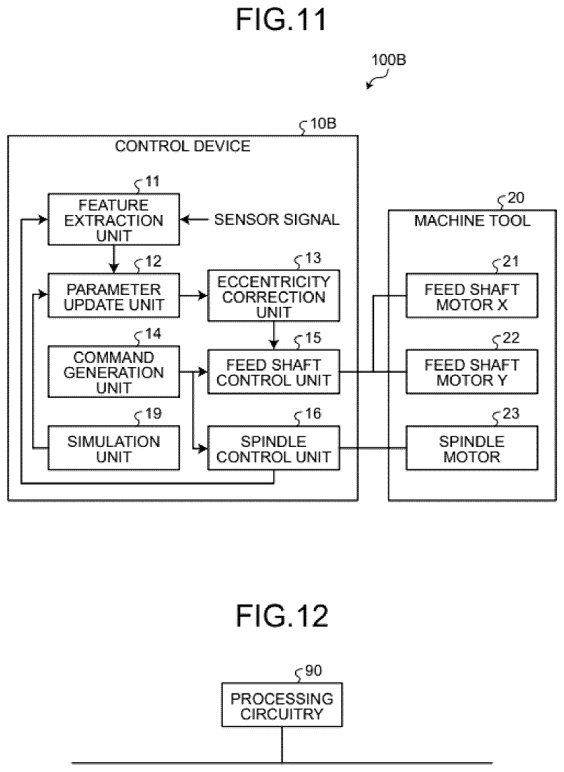

FIG. 11 is a diagram illustrating an exemplary functional configuration of a machine tool system 100B according to a third embodiment. The machine tool system 100B includes a control device 10B and the machine tool 20.

In the first embodiment, the first threshold and the second threshold are values determined by the user of the machine tool system 100 based on experience. In the third embodiment, the control device 10B has a function of determining the first threshold and/or the second threshold using simulation.

The control device 10B includes the feature extraction unit 11, the parameter update unit 12, the eccentricity correction unit 13, the command generation unit 14, the feed shaft control unit 15, the spindle control unit 16, and a simulation unit 19.

Note that although the control device 10B does not include the display unit 17 here for simplicity, the control device 10B may include the display unit 17.

The simulation unit 19 executes a machining simulation that simulates cutting of the machine tool 20 based on the set machining conditions. The simulation unit 19 has a function of calculating vibration during cutting through machining simulation and determining the first threshold and/or the second threshold based on the calculated vibration during cutting. Note that the method of simulation is not particularly limited. The simulation unit 19 outputs the determined threshold to the parameter update unit 12.

The parameter update unit 12 adjusts the correction parameter using the threshold determined by the simulation unit 19.

Note that, although the simulation unit 19 is provided in the control device 10B here, the simulation unit 19 may be provided in a device other than the control device 10B.

The operation of the control device 10B is similar to that in the first embodiment except for the threshold determination method, and thus the description thereof is omitted here.

As described above, the control device 10B according to the third embodiment can further include the simulation unit 19 that executes a machining simulation that simulates the cutting based on set machining conditions to calculate vibration during the cutting, and determines the first threshold and/or the second threshold based on the vibration during the cutting calculated. With such a configuration, the ideal vibration state after the eccentricity correction can be calculated by simulation, and the eccentricity correction can be executed with the ideal vibration state as a target.

Here, hardware configurations of the control devices 10, 10A, and 10B according to the first to third embodiments will be described. The function of each unit of the control devices 10, 10A, and 10B is implemented by processing circuitry. The processing circuitry may be implemented by dedicated hardware or may be a control circuit using a central processing unit (CPU).

In a case where the above processing circuitry is implemented by dedicated hardware, the processing circuitry is implemented by processing circuitry 90 illustrated in FIG. 12. FIG. 12 is a diagram illustrating dedicated hardware for implementing the functions of the control devices 10, 10A, and 10B according to the first to third embodiments. The processing circuitry 90 is a single circuit, a composite circuit, a programmed processor, a parallel programmed processor, an application specific integrated circuit (ASIC), a field programmable gate array (FPGA), or a combination thereof.

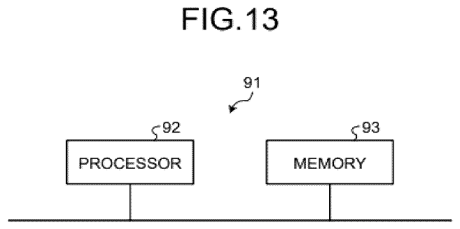

In a case where the above processing circuitry is implemented by a control circuit using a CPU, this control circuit is, for example, a control circuit 91 having the configuration illustrated in FIG. 13. FIG. 13 is a diagram illustrating a configuration of the control circuit 91 for implementing the functions of the control devices 10, 10A, and 10B according to the first to third embodiments. As illustrated in FIG. 13, the control circuit 91 includes a processor 92 and a memory 93. The processor 92 is a CPU, and is also called a processing device, an arithmetic device, a microprocessor, a microcomputer, a digital signal processor (DSP), or the like. Examples of the memory 93 include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

In a case where the above processing circuitry is implemented by the control circuit 91, the processor 92 reads and executes the program corresponding to the process of each component stored in the memory 93, thereby implementing the processing circuitry. The memory 93 is also used as a temporary memory for each process executed by the processor 92. The program may be provided by being stored in a storage medium, or may be provided via a communication path such as the Internet.

The configurations described in the above-mentioned embodiments indicate examples. The embodiments can be combined with another well-known technique or with each other, and some of the configurations can be omitted or changed in a range not departing from the gist.

For example, instead of the feature extraction unit 11 of the control device 10B according to the third embodiment, the feature extraction unit 11A may be included, and the position response characteristic storage unit 18 may be further included. In addition, the control device 10B may further include the display unit 17, or the display unit 17 may be omitted from the control devices 10 and 10A. In addition, the display unit 17 may be implemented by a display device separate from the control devices 10, 10A, and 10B.

Hereinafter, various aspects of the present disclosure will be collectively described as supplements.

### (Supplement 1)

A control device that controls a machine tool that cuts a workpiece through feed operation of a feed shaft attached to a tool and rotation operation of a spindle attached to the tool, the control device comprising:
a feature extraction unit to extract, as a first frequency component, a frequency component of a spindle rotation frequency that is a frequency of rotation of the spindle from a sensor signal indicating vibration during cutting of the tool;
a parameter update unit to adjust a value of a correction parameter such that a first amplitude that is an amplitude of the first frequency component becomes equal to or less than a first threshold in a case where the first amplitude is larger than the first threshold; and
an eccentricity correction unit to generate, based on the correction parameter, a correction command indicating a correction amount for a control command for controlling the feed shaft.

### (Supplement 2)

The control device according to supplement 1, wherein
the feature extraction unit further extracts, from the sensor signal, a second frequency component that is a frequency component of an integral multiple of the spindle rotation frequency, and
in a case where the first amplitude is larger than the first threshold or a second amplitude that is an amplitude of the second frequency component is larger than a second threshold, the parameter update unit adjusts the correction parameter such that the first amplitude becomes equal to or less than the first threshold and the second amplitude becomes equal to or less than the second threshold.

### (Supplement 3)

The control device according to supplement 1 or 2, wherein
the correction command is a sine wave having an angular velocity of the spindle rotation frequency, and
the correction parameter is an amplitude of the sine wave and a phase with respect to a spindle angle.

### (Supplement 4)

The control device according to supplement 3, further comprising:
a position response characteristic storage unit to store previously measured values of a gain and a phase of an actual position with respect to a command position of the feed shaft in association with the spindle rotation frequency, wherein
the feature extraction unit corrects a gain and a phase of the frequency component extracted such that an amplitude of the actual position at a time when the feed shaft is controlled based on the correction command coincides with an amplitude of the command position and a phase difference of the actual position with respect to the correction command decreases, and
the parameter update unit adjusts the correction parameter based on the frequency component after correction.

### (Supplement 5)

The control device according to supplement 1, further comprising:
a simulation unit to execute a machining simulation that simulates the cutting based on set machining conditions to calculate vibration during the cutting, and determine the first threshold based on the vibration during the cutting calculated.

### (Supplement 6)

The control device according to supplement 2, further comprising:
a simulation unit to execute a machining simulation that simulates the cutting based on set machining conditions to calculate vibration during the cutting, and determine the first threshold and/or the second threshold based on the vibration during the cutting calculated.

### (Supplement 7)

The control device according to supplement 1 or 2, further comprising:
a display unit to display the frequency component extracted by the feature extraction unit and/or the correction parameter adjusted by the parameter update unit.

### (Supplement 8)

The control device according to supplement 7, wherein
the display unit displays an absolute value and a time-series change of a value in a visually recognizable manner.

### (Supplement 9)

A machine tool system comprising:
a machine tool to cut a workpiece through feed operation of a feed shaft attached to a tool and rotation operation of a spindle attached to the tool; and
a control device to control the machine tool, wherein
the control device includes:
a feature extraction unit to extract, as a first frequency component, a frequency component of a spindle rotation frequency that is a frequency of rotation of the spindle from a sensor signal indicating vibration during cutting of the tool;
a parameter update unit to adjust a value of a correction parameter such that a first amplitude that is an amplitude of the first frequency component becomes equal to or less than a first threshold in a case where the first amplitude is larger than the first threshold; and
an eccentricity correction unit to generate, based on the correction parameter, a correction command indicating a correction amount for a control command for controlling the feed shaft.

### (Supplement 10)

A method for controlling a machine tool that cuts a workpiece through feed operation of a feed shaft attached to a tool and rotation operation of a spindle attached to the tool, the method comprising:
a step of extracting, as a first frequency component, a frequency component of a spindle rotation frequency that is a frequency of rotation of the spindle from a sensor signal indicating vibration during cutting of the tool;
a step of adjusting a value of a correction parameter such that a first amplitude that is an amplitude of the first frequency component becomes equal to or less than a first threshold in a case where the first amplitude is larger than the first threshold; and
a step of generating, based on the correction parameter, a correction command indicating a correction amount for a control command for controlling the feed shaft.

What is claimed is:

1. A control device that controls a machine tool that cuts a workpiece through feed operation of a feed shaft attached to a tool and rotation operation of a spindle attached to the tool, the control device comprising:
feature extraction circuitry to extract, as a first frequency component, a frequency component of a spindle rotation frequency that is a frequency of rotation of the spindle from a sensor signal indicating vibration during cutting of the tool;
parameter update circuitry to adjust a value of a correction parameter such that a first amplitude that is an amplitude of the first frequency component becomes equal to or less than a first threshold in a case where the first amplitude is larger than the first threshold; and
eccentricity correction circuitry to generate, based on the correction parameter, a correction command indicating a correction amount for a control command for controlling the feed shaft.

2. The control device according to claim 1, wherein
the feature extraction circuitry further extracts, from the sensor signal, a second frequency component that is a frequency component of an integral multiple of the spindle rotation frequency, and
in a case where the first amplitude is larger than the first threshold or a second amplitude that is an amplitude of the second frequency component is larger than a second threshold, the parameter update circuitry adjusts the correction parameter such that the first amplitude becomes equal to or less than the first threshold and the second amplitude becomes equal to or less than the second threshold.

3. The control device according to claim 1, wherein
the correction command is a sine wave having an angular velocity of the spindle rotation frequency, and
the correction parameter is an amplitude of the sine wave and a phase with respect to a spindle angle.

4. The control device according to claim 3, further comprising:
a position response characteristic memory to store previously measured values of a gain and a phase of an actual position with respect to a command position of the feed shaft in association with the spindle rotation frequency, wherein
the feature extraction circuitry corrects a gain and a phase of the frequency component extracted such that an amplitude of the actual position at a time when the feed shaft is controlled based on the correction command coincides with an amplitude of the command position and a phase difference of the actual position with respect to the correction command decreases, and
the parameter update circuitry adjusts the correction parameter based on the frequency component after correction.

5. The control device according to claim 1, further comprising:
simulation circuitry to execute a machining simulation that simulates the cutting based on set machining conditions to calculate vibration during the cutting, and determine the first threshold based on the vibration during the cutting calculated.

6. The control device according to claim 2, further comprising:
simulation circuitry to execute a machining simulation that simulates the cutting based on set machining conditions to calculate vibration during the cutting, and determine the first threshold and/or the second threshold based on the vibration during the cutting calculated.

7. The control device according to claim 1, further comprising:
a display to display the frequency component extracted by the feature extraction circuitry and/or the correction parameter adjusted by the parameter update circuitry.

8. The control device according to claim 7, wherein
the display displays an absolute value and a time-series change of a value in a visually recognizable manner.

9. A machine tool system comprising:
a machine tool to cut a workpiece through feed operation of a feed shaft attached to a tool and rotation operation of a spindle attached to the tool; and
a control device to control the machine tool, wherein
the control device includes:
feature extraction circuitry to extract, as a first frequency component, a frequency component of a spindle rotation frequency that is a frequency of rotation of the spindle from a sensor signal indicating vibration during cutting of the tool;
parameter update circuitry to adjust a value of a correction parameter such that a first amplitude that is an amplitude of the first frequency component becomes equal to or less than a first threshold in a case where the first amplitude is larger than the first threshold; and
eccentricity correction circuitry to generate, based on the correction parameter, a correction command indicating a correction amount for a control command for controlling the feed shaft.

10. A method for controlling a machine tool that cuts a workpiece through feed operation of a feed shaft attached to a tool and rotation operation of a spindle attached to the tool, the method comprising:
extracting, as a first frequency component, a frequency component of a spindle rotation frequency that is a frequency of rotation of the spindle from a sensor signal indicating vibration during cutting of the tool;
adjusting a value of a correction parameter such that a first amplitude that is an amplitude of the first frequency component becomes equal to or less than a first threshold in a case where the first amplitude is larger than the first threshold; and
generating, based on the correction parameter, a correction command indicating a correction amount for a control command for controlling the feed shaft.
